(19) United States
(12) Patent Application Publication
(10) Pub. No.: US 2012/0060130 A1
(43) Pub. Date: Mar. 8, 2012

(54) SCREENSAVER DISPLAY SYSTEM AND METHOD

(75) Inventor: TING-CHIEH LIN, Tu-Cheng (TW)

(73) Assignee: HON HAI PRECISION INDUSTRY CO., LTD., Tu-Cheng (TW)

(21) Appl. No.: 13/164,911

(22) Filed: Jun. 21, 2011

(30) Foreign Application Priority Data
Sep. 8, 2010 (CN) 201010275659.X

(51) Int. Cl. G06F 3/01

(52) U.S. Cl. 715/867

(57) ABSTRACT

A screensaver display system of an electronic device includes a timer, an event monitor, a timer controller, a first determining unit, a screensaver generator, and a display module. The timer controller instructs the timer to restart timing when the event monitor detects the occurrence of a predetermined event. The first determining unit determines whether the timer reaches a first threshold. The screensaver generator generates a screensaver, and the display module displays the screensaver to overlay a screen of a display unit of the electronic device.

### BACKGROUND

1. Technical Field

The disclosure generally relates to a screensaver display system and a method of displaying a screensaver.

2. Description of Related Art

Computer and television screens are susceptible to a problem called “burn-in”. Burn-in results from a static image on a screen for a certain period of time which causes the image to be burned on the screen. There is a need for a system and a method for displaying screensavers.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a screensaver display system installed in an electronic device.

FIG. 2 is a flowchart of one embodiment of a screensaver display method using the screensaver display system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an erasable programmable read only memory, known as the EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

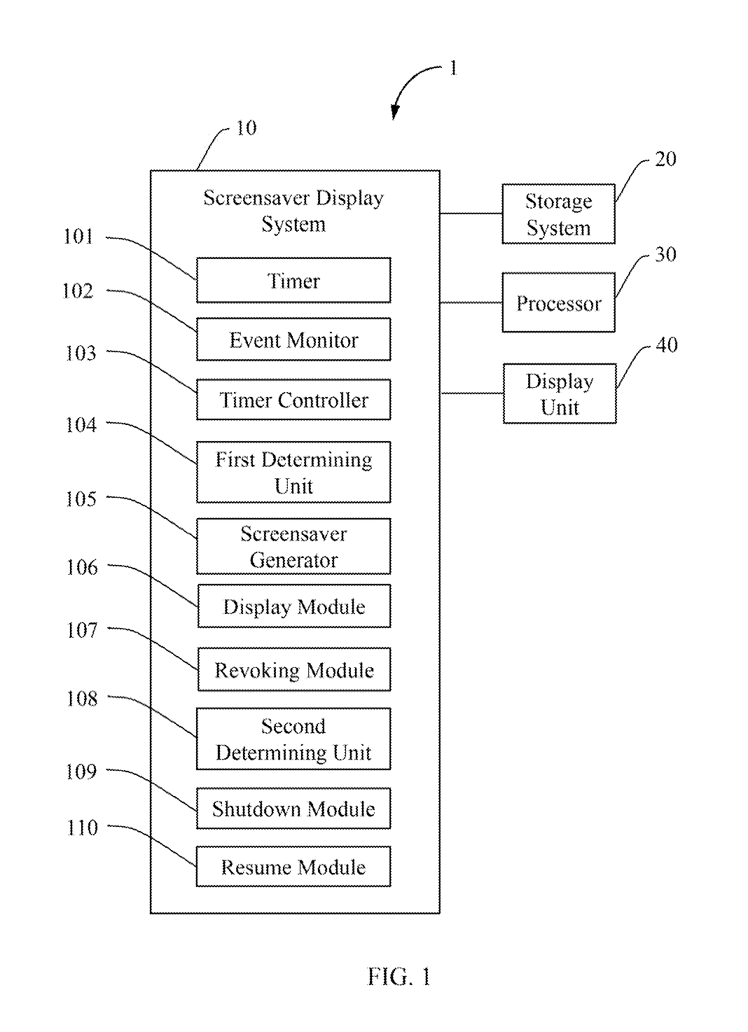

FIG. 1 is a schematic diagram of one embodiment of an electronic device 1. In the embodiment, the electronic device 1 may include a screensaver display system 10, a storage system 20, at least one processor 30, and a display unit 40. The screensaver display system 10 may display a screensaver in the display unit 40 of the electronic device 1. One or more computerized codes of the screensaver display system 10 are stored in the storage system 20 and executed by the at least one processor 30. The display unit 40 is operable to display the screensaver.

In one embodiment, the storage system 20 may be a magnetic or an optical storage system, such as a hard disk drive, an optical drive, or a tape drive. The storage system 20 also stores corresponding screensavers generated by the screensaver display system 10. The display unit 40 may be a display screen, such as a liquid crystal display (LCD) or a cathode-ray tube (CRT) display.

In one embodiment, the screensaver display system 10 includes a timer 101, an event monitor 102, a timer controller 103, a first determining unit 104, a screensaver generator 105, a display module 106, a revoking module 107, a second determining unit 108, a shutdown module 109 and a resume module 110. Each of the modules 101-110 may be a software program including one or more computerized instructions that are stored in the storage system 20 and executed by the processor 30.

The timer 101 may start timing when a starting command is instructed. When the timer 101 is timing and a restart command is instructed, the timer 101 may initialize the time and restart timing.

The event monitor 102 may detect the occurrence of a predetermined event in the electronic device 1. The predetermined event may be a hardware event or a software event. A hardware event is a kind of activity coupled with hardware. For example, a hardware event may be the press of a key on a keyboard, the touch on a touch-sensive screen, the press of a power button, or the plugging & unplugging of a USB device. A software event is an event in connection with a certain application. For example, a software event may be an emergency message, a phone call, or a clock alarm.

The timer controller 103 may instruct the timer 101 to restart timing when the event monitor 102 detects the occurrence of a predetermined event.

The first determining unit 104 determines whether the timer 101 reaches a first threshold. The first threshold is a predetermined period of time as an activation condition of displaying a screensaver. For example, a period of 5 minutes may be set as the first threshold.

The screensaver generator 105 generates a screensaver when the timer 101 reaches the first threshold. A screensaver can include textual, pictorial or visual still or moving images, and/or audio content.

The display module 106 may display the screensaver to overlay the screen of the display unit 40.

The revoking module 107 may revoke displaying the screensaver when the event monitor 102 detects the occurrence of a predetermined event.

The second determining unit 108 determines whether the timer 101 reaches a second threshold. The second threshold is a predetermined period of time as an activation condition of shutting down the display unit 40. The second threshold is longer than the first threshold.

The shutdown module 109 may shut down the display unit 40 when the timer 101 times reaches the second threshold.

The resume module 110 may resume the display unit 40 when the event monitor 102 detects the occurrence of a predetermined event.

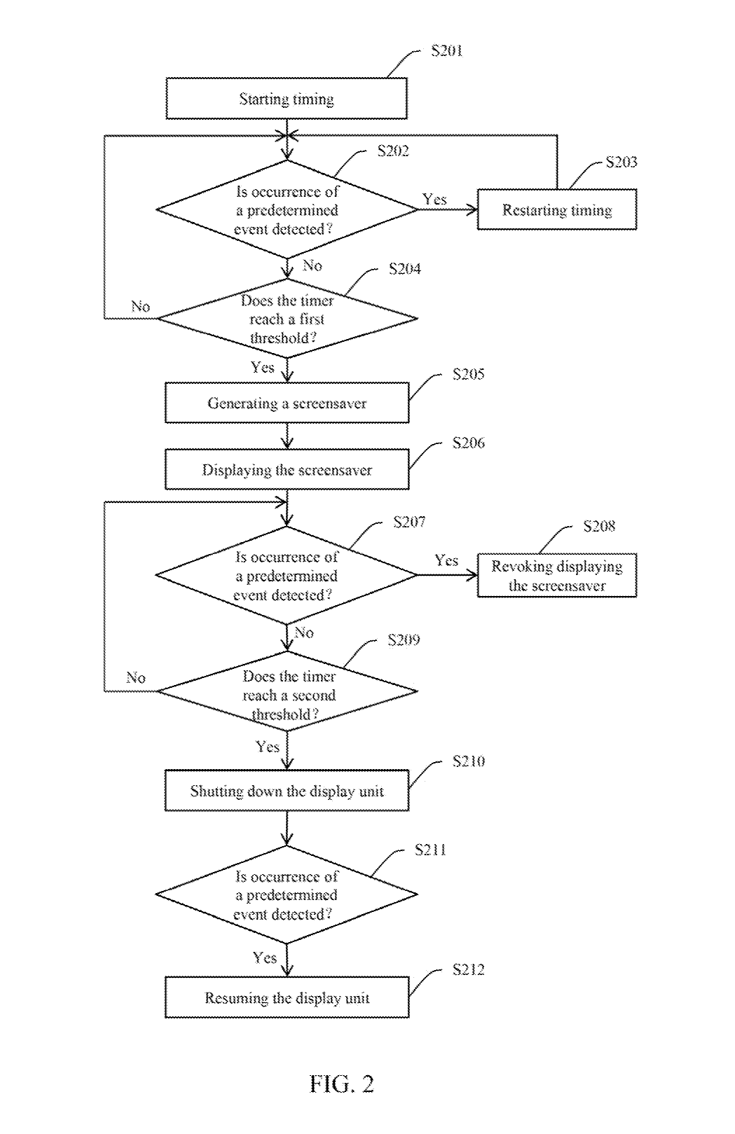

FIG. 2 is a flowchart illustrating one embodiment of a screensaver display method using the screensaver display system of FIG. 1. The method may include the following blocks.

In block S201, the timer 101 starts timing

In block S202, if the event monitor 102 detects the occurrence of a predetermined event in the electronic device 1, the method proceeds to block S203. If no occurrence of any predetermined event is detected, the method proceeds to block S204.

In block S203, the timer controller 103 instructs the timer 101 to restart timing, and the method proceeds to block S202.

In block S204, the first determining unit 104 determines whether the timer 101 reaches the first threshold. If the timer 101 reaches the first threshold, the method proceeds to block S205. If the timer 101 does not reach the first threshold, the method proceeds to block S202.

In block S205, the screensaver generator 105 generates a screensaver. A screensaver may be a motion image or a video.

In block S206, the display module 106 displays the screensaver to overlay the screen of the display unit 40.

In block S207, if the event monitor 102 detects the occurrence of a predetermined event in the electronic device 1, the method proceeds to block S208. If no occurrence of any predetermined event is detected, the method proceeds to block S209.

In block S208, the revoking module 107 revokes displaying the screensaver.

In block S209, the second determining unit 108 determines whether the timer 101 reaches the second threshold. If the timer 101 reaches the second threshold, the method proceeds to block S210. If the timer 101 does not reach the second threshold, the method proceeds to block S217.

In block S210, the shutdown module 109 shuts down the display unit 40.

In block S211, if the event monitor 102 detects the occurrence of a predetermined event in the electronic device 1, the method proceeds to block S212.

In block S212, the resume module 110 resumes the display unit 40.

Depending on the embodiment, certain blocks of methods described may be removed, others may be added, and the sequence of blocks may be altered. It is also to be understood that the description and the claims drawn to a method may include some indication in reference to certain blocks. However, the indication used is only to be viewed for identification purposes and not as a suggestion as to an order for the blocks.

What is claimed is:

1. A method of displaying a screensaver in a display unit of an electronic device, the method comprising:
starting timing by a timer;
restarting timing by the timer in response to detecting the occurrence of a predetermined event in the electronic device;
determining whether the timer reaches a first threshold, the first threshold being a predetermined period of time as an activation condition of displaying the screensaver;
generating a screensaver when the timer times reaches the first threshold; and
displaying the screensaver to overlay a screen of the display unit.

2. The method of the claim 1, further comprising revoking displaying the screensaver in response to detecting an occurrence of a predetermined event in the electronic device after displaying the screensaver.

3. The method of the claim 1, further comprising:
determining whether the timer reaches a second threshold, the second threshold being a predetermined period of time as an activation condition of shutting down the display unit; and
shutting down the display unit when the timer reaches the second threshold.

4. The method of the claim 3, wherein the second threshold is longer than the first threshold.

5. The method of the claim 3, further comprising resuming the display unit in response to detecting an occurrence of a predetermined event in the electronic device after shutting down the display unit.

6. The method of the claim 1, wherein the predetermined event is a predetermined hardware event or a predetermined software event.

7. A system for displaying a screensaver in a display unit of an electronic device, the system comprising:
a timer;
an event monitor adapted to detect the occurrence of a predetermined event in the electronic device;
a timer controller adapted to instruct the timer to restart timing when the event monitor detects the occurrence of the predetermined event;
a first determining unit adapted to determine whether the timer reaches a first threshold, the first threshold being a predetermined period of time as an activation condition of displaying the screensaver;
a screensaver generator adapted to generate the screensaver when the timer reaches the first threshold; and
a display module adapted to display the screensaver to overlay a screen of the display unit.

8. The system of the claim 7, further comprising a revoking module adapted to revoke displaying the screensaver when the event monitor detects an occurrence of a predetermined event.

9. The system of the claim 7, further comprising:
a second determining unit adapted to determine whether the timer reaches a second threshold, the second threshold being a predetermined period of time as an activation condition of shutting down the display unit; and
a shutdown module adapted to shut down the display unit when the timer reaches the second threshold.

10. The system of the claim 9, wherein the second threshold is longer than the first threshold.

11. The system of the claim 9, further comprising a resume module adapted to resume the display unit when the event monitor detects the occurrence of the predetermined event.

12. The method of the claim 7, wherein the predetermined event is one of a predetermined hardware event and a predetermined software event.

13. A non-transitory storage medium having stored thereon instructions that, when executed by a processor of an electronic device, cause the electronic device to perform a screensaver displaying method, the method comprising:
starting timing by a timer;
restarting timing by the timer in response to detecting the occurrence of a predetermined event in the electronic device;
determining whether the timer reaches a first threshold, the first threshold being a predetermined period of time as an activation condition of displaying the screensaver;
generating a screensaver when the timer reaches the first threshold; and
displaying the screensaver to overlay a screen of a display unit of the electronic device.

14. The storage medium of the claim 13, wherein the method further comprises
revoking displaying the screensaver in response to detecting an occurrence of a predetermined event in the electronic device after displaying the screensaver.

15. The storage medium of the claim 13, wherein the method further comprises:
determining whether the timer reaches a second threshold, the second threshold being a predetermined period of time as an activation condition of shutting down the display unit; and
shutting down the display unit when the timer reaches the second threshold.

16. The storage medium of the claim 15, wherein the second threshold is longer than the first threshold.

17. The storage medium of the claim 15, wherein the method further comprises
resuming the display unit in response to detecting an occurrence of a predetermined event in the electronic device after shutting down the display unit.

18. The storage medium of the claim 13, wherein the predetermined event is one of a predetermined hardware event and a predetermined software event.
